(19) United States
(12) Patent Application Publication
(10) Pub. No.: US 2013/0033425 A1
(43) Pub. Date: Feb. 7, 2013

(54) INFORMATION PROCESSOR AND INFORMATION PROCESSING METHOD

(71) Applicants: Hiroshi Yamaguchi, Tokyo (JP); Tomohiko Sakamoto, Tokyo (JP)

(72) Inventors: Hiroshi Yamaguchi, Tokyo (JP); Tomohiko Sakamoto, Tokyo (JP)

(73) Assignee: SONY CORPORATION, Tokyo (JP)

(21) Appl. No.: 13/559,830

(22) Filed: Jul. 27, 2012

(30) Foreign Application Priority Data
Aug. 5, 2011 (JP) 2011-171637

(51) Int. Cl. G06F 3/033

(52) U.S. Cl. 345/157

(57) ABSTRACT

Provided an information processor, including a detection target recognition section that recognizes a detection target based on a movement status of a pointer or a movement status of an imaging target which are detected based on a captured image; and an object detection section that detects an object from a recognized detection target.

### CROSS-REFERENCE TO RELATED APPLICATION

The present application claims priority from Japanese Patent Application No. JP 2011-171637 filed in the Japanese Patent Office on Aug. 5, 2011, the entire content of which is incorporated herein by reference.

### BACKGROUND

The present disclosure relates to an information processor and an information processing method.

In these days, there are widely prevailing apparatuses capable of recognizing objects such as characters, specific things or the like by applying OCR (optical character recognition) and image analysis.

Also, technologies relevant to the recognition of characters have been developed. As for a technology for recognizing characters based on positions and postures of a hand and fingers of a user, for example, a technology taught by Japanese Unexamined Patent Application Publication No. 2003-108923 is known.

### SUMMARY

For example, Japanese Unexamined Patent Application Publication No. 2003-108923 teaches a technology relevant to the recognition of characters (hereinafter, referred to as “related art”) in which two operation postures of user's hand and fingers; i.e., a pointing posture and a selecting posture are set. Also, in the related art, a hand and fingers of a user are detected from a captured image and postures and positions of the hand and fingers of the user are recognized to thereby specify an area for recognizing characters. In the related art, character recognition processing is made on the specified area. Thus, by using the related art, specific characters specified in the captured image can be recognized.

However, in order to set an area in which the apparatus recognizes characters, a user of an apparatus employing the related art is required to perform plural different operations; i.e., an operation relevant to a pointing posture and an operation relevant to a selecting posture. Therefore, since the user of the apparatus employing the related art has to perform complicated operations, intuitive operation is hardly performed.

The present disclosure proposes a novel and improved information processor and an information processing method capable of recognizing objects while providing the user with an enhanced operability.

The present disclosure provides an information processor which includes a detection target recognition section that recognizes a detection target based on a movement status of a pointer or a movement status of an imaging target which is detected based on a captured image; and an object detection section that detects an object from a recognized detection target.

Also, the present disclosure provides an information processing method which includes: recognizing a detection target based on a movement status of a pointer or a movement status of an imaging target which are detected based on a captured image; and detecting an object from a recognized detection target.

According to the present disclosure, objects can be recognized while providing the user with an enhanced operability.

### BRIEF DESCRIPTION OF THE DRAWINGS

FIG. 1 is an illustration explaining an example of a captured image which is processed by an information processor according to the embodiment of the present disclosure;

FIG. 2 is an illustration explaining an example of a captured image which is processed by the information processor according to the embodiment of the present disclosure;

FIG. 3 is a flow chart showing an example of processing in accordance with an information processing method according to the embodiment of the present disclosure;

FIG. 4 is a flow chart showing a first example of processing relevant to the recognition of a detection target when recognizing a pointer in the information processor according to the embodiment of the present disclosure;

FIG. 5 is an illustration showing an example of processing to recognize the detection target based on a positional track of the pointer in the information processor according to the embodiment of the present disclosure;

FIG. 6 is an illustration showing an example of processing to recognize the detection target based on the positional track of the pointer in the information processor according to the embodiment of the present disclosure;

FIG. 7 is an illustration showing an example of processing to recognize the detection target based on the positional track of the pointer in the information processor according to the embodiment of the present disclosure;

FIG. 8 is an illustration showing an example of processing to recognize the detection target based on the positional track of the pointer in the information processor according to the embodiment of the present disclosure;

FIG. 9 is an illustration showing an example of processing to recognize the detection target based on the positional track of the pointer in the information processor according to the embodiment of the present disclosure;

FIG. 10 is an illustration showing an example of processing to recognize the detection target based on the positional track of the pointer in the information processor according to the embodiment of the present disclosure;

FIG. 11 is a flow chart showing a second example of processing relevant to the recognition of a detection target when recognizing a pointer in the information processor according to the embodiment of the present disclosure;

FIG. 12 is a flow chart showing a third example of processing relevant to the recognition of a detection target when recognizing an pointer in the information processor according to the embodiment of the present disclosure;

FIG. 13 is a flow chart showing a fourth example of processing relevant to the recognition of a detection target when recognizing an pointer in the information processor according to the embodiment of the present disclosure;

FIG. 14 is a flow chart showing a fifth example of processing relevant to the recognition of a detection target when recognizing an pointer in the information processor according to the embodiment of the present disclosure;

FIG. 15 is a flow chart showing a sixth example of processing relevant to the recognition of a detection target when recognizing an pointer in the information processor according to the embodiment of the present disclosure;

FIG. 16 is a flow chart showing a seventh example of processing relevant to the recognition of a detection target when recognizing an pointer in the information processor according to the embodiment of the present disclosure;

FIG. 17 is an illustration explaining an example of processing relevant to the recognition of a detection target when the pointer is not recognized in the information processor according to the embodiment of the present disclosure;

FIG. 18 is an illustration explaining an example of processing relevant to the recognition of a detection target when the pointer is not recognized in the information processor according to the embodiment of the present disclosure;

FIG. 19 is a block diagram illustrating an example of a configuration of the information processor according to the embodiment of the present disclosure; and

FIG. 20 is an illustration showing an example a hardware configuration of the information processor according to the embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made below in the following order.

1. Information processing method according to the embodiment of the present disclosure

2. Information processor according to the embodiment of the present disclosure

3. Program according to the embodiment of the present disclosure

### (Information Processing Method According to the Embodiment of the Present Disclosure)

Prior to a description of a configuration of an information processor according to the embodiment of the present disclosure (hereinafter, referred to as “information processor 100”), an information processing method according to the embodiment of the present disclosure will be described first. In the following description, it is assumed that the information processor according to the embodiment of the present disclosure performs the information processing method according to the embodiment of the present disclosure.

### [Outline of Information Processing Method According to the Embodiment of the Present Disclosure]

As described above, for example, using an apparatus which employs the related art, when a user specifies an area in a captured image (hereinafter, referred to as “captured image”) to recognize characters (an example of an object) by recognizing a plurality of postures of a hand and fingers of the user, it may be difficult for the user employing the apparatus to perform intuitive operation.

The information processor 100 determines a movement status of a pointer, or a movement status of an imaging target such as, for example, fingers of a user, an pointing device or the like based on the captured image (moving image, or a plurality of still images; hereinafter referred to identically), and recognizes a detection target (target) (detection target recognition processing). Here, the detection target according to the embodiment of the present disclosure means a target of the object detection processing describe below.

In particular, when recognizing the detection target by determining the movement status of the pointer, the information processor 100 determines the movement status of the pointer based on, for example, the positional track of the pointer in the captured image. When recognizing the detection target by determining the movement status of the imaging target, the information processor 100 determines the movement status of the imaging target based on, for example, the change of the image with respect to a predetermined point such as a center position and the like of the captured image. A particular example of the processing relevant to the determination of the movement status of the pointer based on the positional track of the pointer, and a particular example of the processing relevant to the determination of the movement status of the imaging target based on the change of the image with respect to a predetermined point of the captured image will be described below.

The information processor 100 detects a specific object from the recognized detection target by using, for example, an OCR technology or an image analysis technology (object detection processing). Here, as for the object according to the embodiment of the present disclosure, for example, characters and a specific object (for example, a human, a material object of a vehicle and the like) are exemplified. In the object detection processing, the information processor 100 detects, for example, a preset object or an object which is newly set through the user operation and the like as the specific object. Hereinafter, the specific object which is detected by the information processor 100 will be simply referred to as “object.”

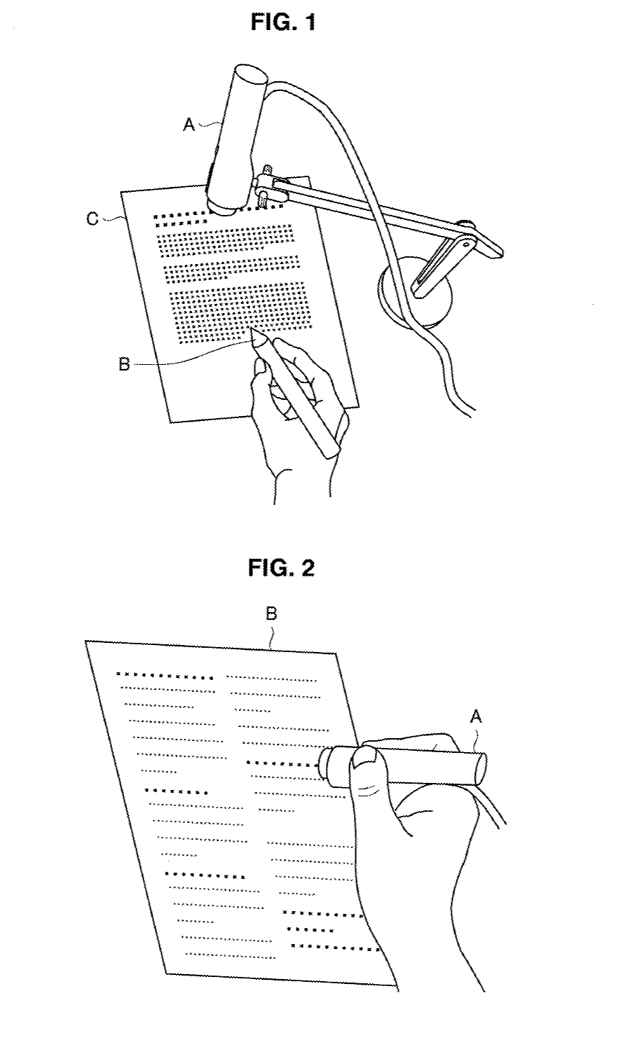

FIG. 1 and FIG. 2 are illustrations each showing an example of the captured image which is processed by the information processor 100 according to the embodiment of the present disclosure. In FIG. 1 and FIG. 2, each item-A is an example of imaging device which picks up an image. In FIG. 1, an item-B is a pointing device as an example of the pointer. An item-C in FIG. 1 and an item-B in FIG. 2 are a paper medium as an example of the imaging target respectively on which characters are recorded. The imaging target according to the embodiment of the present disclosure is not limited to a paper medium as the item-C shown in FIG. 1 and the item-B shown in FIG. 2. For example, the imaging target according to the embodiment of the present disclosure may be a sign, a magazine or the like; any item including the object may be positioned indoor or outdoor.

As for the captured image according to the embodiment of the present disclosure, for example, an image captured by an imaging device the imaging position of which is fixed as the item-A shown in FIG. 1; or an image captured by an imaging device the imaging position of which is not fixed as the item-A shown in FIG. 2 is exemplified. When recognizing the detection target based on the captured image taken by an imaging device like the item-A in FIG. 1, the information processor 100 determines the movement status of the pointer and recognizes the detection target. Also, when recognizing the detection target based on the captured image taken by an imaging device like the item-A in FIG. 2, the information processor 100 determines the movement status of the imaging target and recognizes the detection target.

The information processor 100 processes, for example, image signals representing the captured image which are received from the imaging device which is connected to the information processor 100 via a wired/wireless network (or, directly), and performs the processing based on the captured image. As for the network according to the embodiment of the present disclosure, for example, a wired network of a LAN (local area network) or a WAN (wide area network) and the like, a wireless network like a wireless LAN (WLAN; wireless local area network) or a radio network of a wireless WAN (WWAN; wireless wide area network) via a base station, or Internet using a communication protocol of TCP/IP (transmission control protocol/Internet protocol) and the like are applicable.

The image signals processed by the information processor 100 according to the embodiment of the present disclosure are not limited to the above. As for the image signals according to the embodiment of the present disclosure, for example, image signals which are obtained by the information processor 100 by receiving airwaves which are transmitted from a TV tower and the like (directly, or indirectly via a set-top box or the like) and decoded. The information processor 100 may process, for example, image signals which are obtained by decoding image data stored in a storage (described below) or an external recording medium which is detachable from the information processor 100. Further, when the information processor 100 includes an imaging section (described below) which is capable of taking moving image, i.e., when the information processor 100 functions as an imaging device, the information processor 100 may processes image signals, for example, corresponding to the captured image taken by the imaging section (described below).

As described above, the information processor 100 according to the embodiment of the present disclosure performs (I): detection target recognition processing and (II) object detection processing to thereby detect the object based on the captured image. The information processor 100 determines the movement status of the pointer or the movement status of the imaging target based on the captured image to thereby recognize the detection target. That is, different from the case in which the related art is employed, the user of the information processor 100 (hereinafter, simply referred to as “user”) may not perform plural different operations such as the operation relevant to the pointing posture and the operation relevant to the selecting posture. Also, the information processor 100 uses, for example, an OCR technology or an image analysis technology to thereby detect a specific object from the recognized detection target. Therefore, compared to the case using an apparatus in which the related art is employed, the user can control the information processor 100 to detect the object with an intuitive operation.

Therefore, the information processor 100 can recognize the object while providing the user with an enhanced operability.

The information processing method according to the embodiment of the present disclosure is not limited to the processing (I): (detection target recognition processing) and the processing (II): (object detection processing). For example, the information processor 100 is capable of performing the processing corresponding to the object based on the detected object (execution processing).

The (III): execution processing by the information processor 100 according to the embodiment of the present disclosure includes, for example, execution of a service relevant to the processing corresponding to the object, execution by activating an application corresponding to the object and the like. In particular, for example, when characters are detected as the object, the information processor 100 performs the processing, for example, “to present a translation result of the detected characters”, “to present a map corresponding to the toponym represented by the detected characters” or the like. Also, for example, when a person is detected as the object, the information processor 100 performs the processing, for example, “to search a memory medium of a storage (described below) or the like for an image including the detected person”. Further, the information processor 100 may mash up plural processing results based on detected object. Needless to say, the processing performed by the information processor 100 according to the embodiment of the present disclosure is not limited to the above examples.

### [Particular Examples of Information Processing Method According to the Embodiment of the Present Disclosure]

Subsequently, the information processing method according to the embodiment of the present disclosure will be particularly described. In the following description, it is assumed that the information processor 100 according to the embodiment of the present disclosure performs processing relevant to the information processing method according to the embodiment of the present disclosure. The following description will give an example in which the information processor 100 detects characters (or a character string; hereinafter, the same) as the object. Also, the following description will give an example in which the information processor 100 processes the captured images which are moving images including images of plural frames (hereinafter, referred to as “frame image”).

In order to describe simply, the following description will give an example in which the object has no inclination in the captured image such as characters or the like. Even when the object in the captured image has an inclination, since the information processor 100 according to the embodiment of the present disclosure is capable of correcting the inclination of the captured image same as the case the object with no inclination.

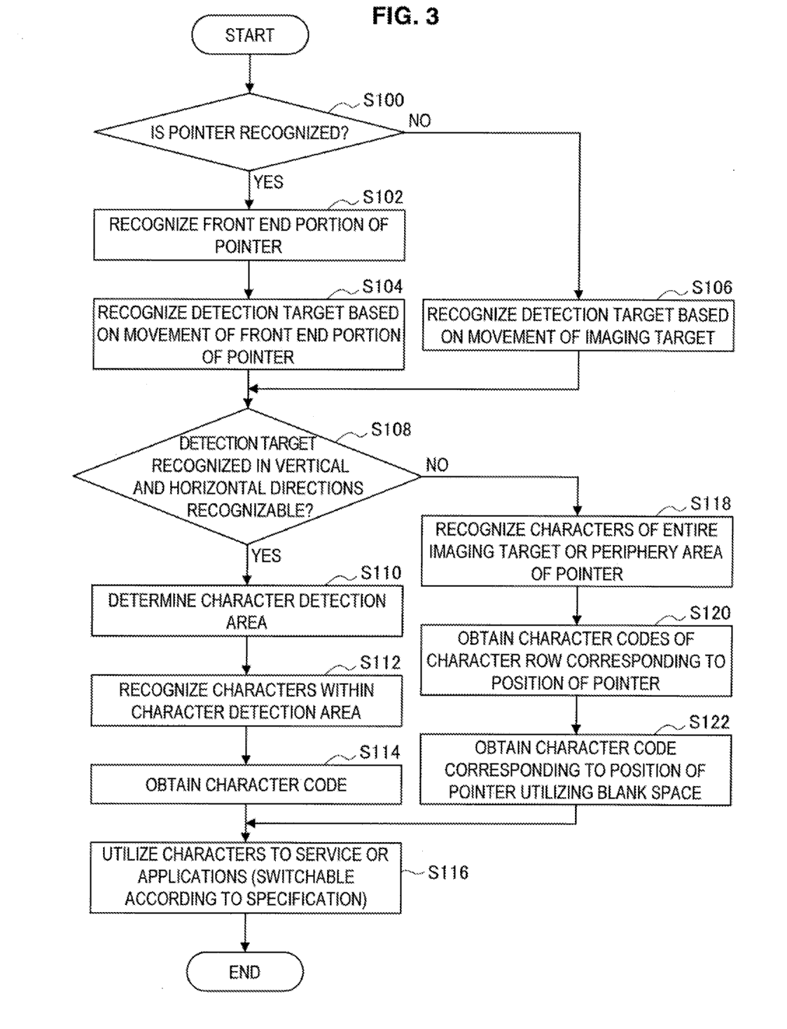

FIG. 3 is a flow chart illustrating an example of the information processing method according to the embodiment of the present disclosure. The processing of steps from S100 to S106 shown in FIG. 3 is the above processing (I): (detection target recognition processing). The processing from step S108 to S114, and from S118 to S122 in FIG. 3 is the above processing (II): (object detection processing). And the processing of step S116 in FIG. 3 is the above processing (III): (execution processing).

The information processor 100 determines whether or not to recognize the pointer (S100). The information processor 100 performs the processing in step S100 based on, for example, the setting information which prescribes whether the pointer should be recognized. The setting information is stored in, for example, the storage (not shown) and the like. The setting information may be, for example, preset or may be set based on the user's operation and the like.

The processing made by the information processor 100 according to the embodiment of the present disclosure in step S100 is not limited to the above. For example, the information processor 100 may determine based on the captured image of the processing object in step S100. For example, the information processor 100 may perform the processing on continuous plural frame images to detect a movement. When no movement is detected on the imaging target, the information processor 100 determines to recognize the pointer. When a movement of the imaging target is detected, the information processor 100 determines not to recognize the pointer. Here, the information processor 100 detects a movement vector by using, for example, a gradient method or the like to detect the movement of the imaging target. However, the movement detection processing of the information processor 100 is not limited to the above.

### [1] Example of Processing to Recognize Pointer

When it is determined to recognize the pointer in step S100, the information processor 100 recognizes, for example, a front end portion of the pointer from the captured image (S102), and recognizes the detection target based on the movement of the recognized front end portion (S104).

The information processor 100 recognizes the front end portion of the pointer by, for example, detecting an edge from the captured image and detecting the profile of the pointer. The recognition method of the front end portion of the pointer by the information processor 100 is not limited to the above. For example, the information processor 100 may recognize the front end portion of the pointer by detecting a specific mark or the like given to the front end portion of the pointing device (an example of pointer) from the captured image. FIG. 3 illustrates an example in which the information processor 100 recognizes the front end portion of the pointer in step S102. However, needless to say, the processing of the information processor 100 in step S102 is not limited to the recognition of the front end portion of the pointer.

Now, a particular description will be given about the processing to recognize the detection target when the information processor 100 recognizes the pointer.

### [1-1] First Example of Processing to Recognize Detection Target

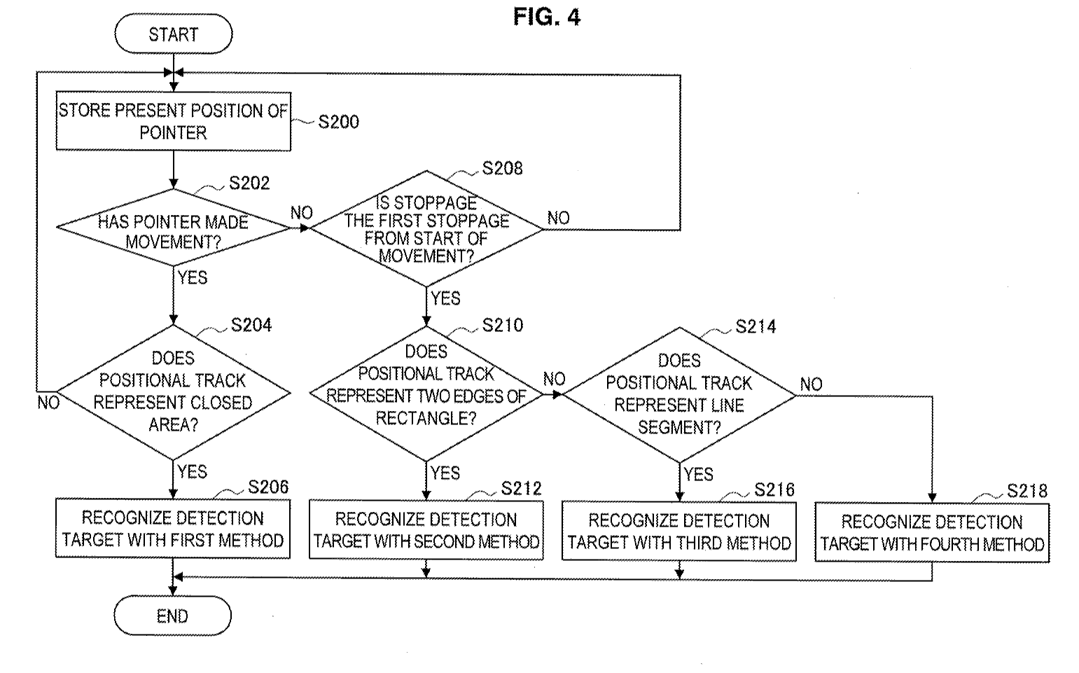

FIG. 4 is a flow chart illustrating a first example of the processing to recognize the detection target when the information processor 100 according to the embodiment of the present disclosure recognizes the pointer.

The information processor 100 stores a position of the pointer in the captured image (a position of the pointer in one frame image corresponding to a moment of the processing (present position)) (S200). According to the embodiment of the present disclosure, the position of the pointer of the captured image is represented by a coordinate which has the coordinate origin at, for example, a specific position in a left-lower corner of the captured image.

When the present position of the pointer is stored in step S200, the information processor 100 determines whether the pointer has made a movement (S202). The information processor 100 compares, for example, the position stored in step S200 with the next time-continuous frame image, or the position of the pointer in a frame image after a certain time has passed; to thereby perform the processing in step S202.

When it is determined that the pointer has made a movement in step S202, the information processor 100 determines whether the positional track of the pointer represents a closed area (S204). The information processor 100 appropriately uses, for example, the information (position data) on the position of the pointer stored in step S200 in time series; to thereby determine the positional track of the pointer.

When it is determined that the positional track of the pointer does not represent a closed area in step S204, the information processor 100 repeats the processing from step S200.

When it is determined that the positional track of the pointer represents closed area in step S204, the information processor 100 recognizes the detection target with a first method based on the determination of the closed area (S206), and terminates the detection target recognition processing.

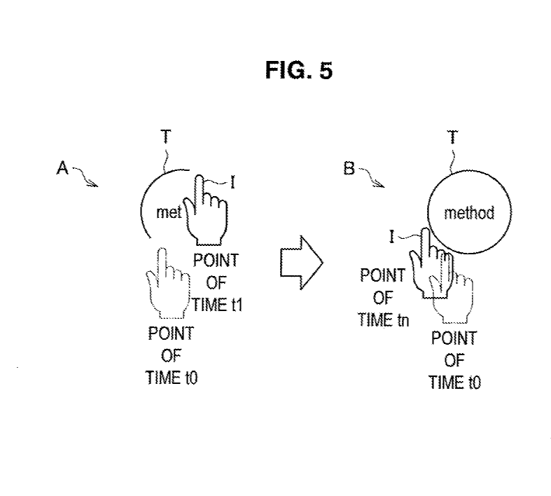

FIG. 5 is an illustration showing an example of the processing to recognize the detection target based on the positional track of the pointer which is made by the information processor 100 according to the embodiment of the present disclosure. FIG. 5 illustrates an example of the processing relevant to the first method based on the determination of the closed area. “I” in FIG. 5 represents an example of the pointer; “T” in FIG. 5 represents a positional track of the pointer. Hereinafter, the positional track of the pointer may be referred to as “track T.”

When the track T does not represent a closed area as shown in FIG. 5A, the information processor 100 does not determine that the positional track of the pointer represents a closed area in step S204, and repeats the processing from step S200. On the other hand, when the track T represents a closed area as shown in FIG. 5B, the information processor 100 recognizes the closed area as the detection target. Therefore, for example, in the example shown in FIG. 5B, a set of characters of “method” is detected through the processing (II): (object detection processing).

Referring to FIG. 4 again, a first example of the processing to recognize the detection target when the information processor 100 recognizes the pointer will be described. When it is determined that the pointer has made no movement in step S202, the information processor 100 determines whether the stoppage is the first stoppage from the start of the movement (S208). The information processor 100 makes the determination in step S208 based on, for example, a counter value which is counted up when it is determined that the pointer has made no movement in step S202. The above counter value is reset before the processing in FIG. 4 starts for example. Needless to say that the processing in step S208 made by the information processor 100 according to the embodiment of the present disclosure is not limited to the above.

When it is determined that the stoppage is not the first stoppage from the start of the movement in step S208, the information processor 100 repeats the processing from step S200.

When it is determined that the stoppage is the first stoppage from the start of the movement in step S208, the information processor 100 determines whether the positional track of the pointer represents two edges of a rectangle (S210).

When it is determined that the positional track of the pointer represents two edges of a rectangle in step S210, the information processor 100 recognizes the detection target with a second method based on the determination of the two edges of a rectangle (S212), and terminates the detection target recognition processing.

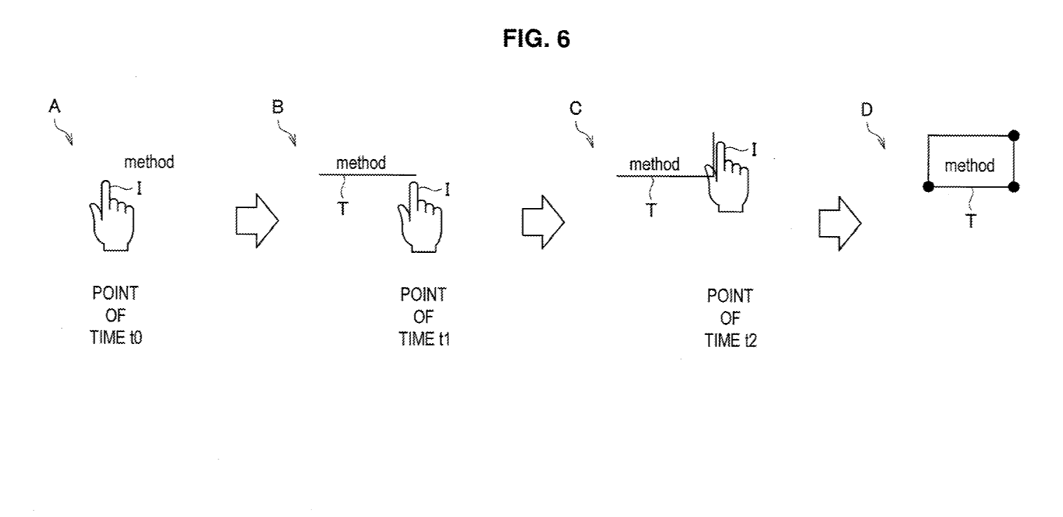

FIG. 6 is an illustration showing an example of the processing based on the positional track of the pointer which is made by the information processor 100 according to the embodiment of the present disclosure performs to recognize the detection target. FIG. 6 illustrates an example of the processing of the second method based on the determination of two edges of a rectangle. “I” in FIG. 6 represents an example of the pointer; “T” in FIG. 6 represents a positional track of the pointer.

For example, as shown in FIGS. 6A-6C, when the user stops the pointer once at a point of time t0, and draws a line segment up to a point of time t1, and then the user draws a line segment perpendicular (generally perpendicular) to the previous line segment up to a point of time t2, the track of the pointer from a stop to the next stop represents two line segments which are bent upward at a right angle (generally right angle) at a point therebetween as shown in FIG. 6D. As described above, when the track of the pointer represents two line segments which are bent at a right angle (generally right angle) at a point therebetween, the information processor 100 determines that the positional track of the pointer represents two edges of a rectangle in step S210. For example, when an angle formed by two line segments therebetween satisfies a condition “90−α<θ<90+α” (α is a preset threshold value), the information processor 100 determines that the track of the pointer represents two line segments which are bent at a right angle (generally right angle) at a point therebetween. Needless to say that the processing in step S210 is not limited to the above.

When it is determined that the positional track of the pointer represents two edges of a rectangle, the information processor 100 recognizes the rectangle area as the detection target, which is prescribed by three points; i.e., the first stop position, the first bending position and the next stop position. That is, the information processor 100 estimates a closed area based on the two edges of the rectangle, and recognizes the same as the detection target. Accordingly, for example, in the example shown in FIG. 6D, a set of characters “method” is detected through the processing (II): (object detection processing).

On the other hand, when the track of the pointer from a stop to the next stop does not include two line segments bent at a right angle (generally right angle) at a point therebetween, the information processor 100 does not determine that the positional track of the pointer represents two edges of a rectangle in step S210.

Referring to FIG. 4 again, a description is made about the first example of the processing to recognize the detection target which is made by the information processor 100 to recognize the pointer. When it is determined that positional track of the pointer does not represent two edges of a rectangle in step S210, the information processor 100 determines whether the positional track of the pointer represents a line segment (S214).

When it is determined that the positional track of the pointer represents a line segment in step S214, the information processor 100 recognizes the detection target with a third method based on the determination of the line segment (S216), and terminates the detection target recognition processing.

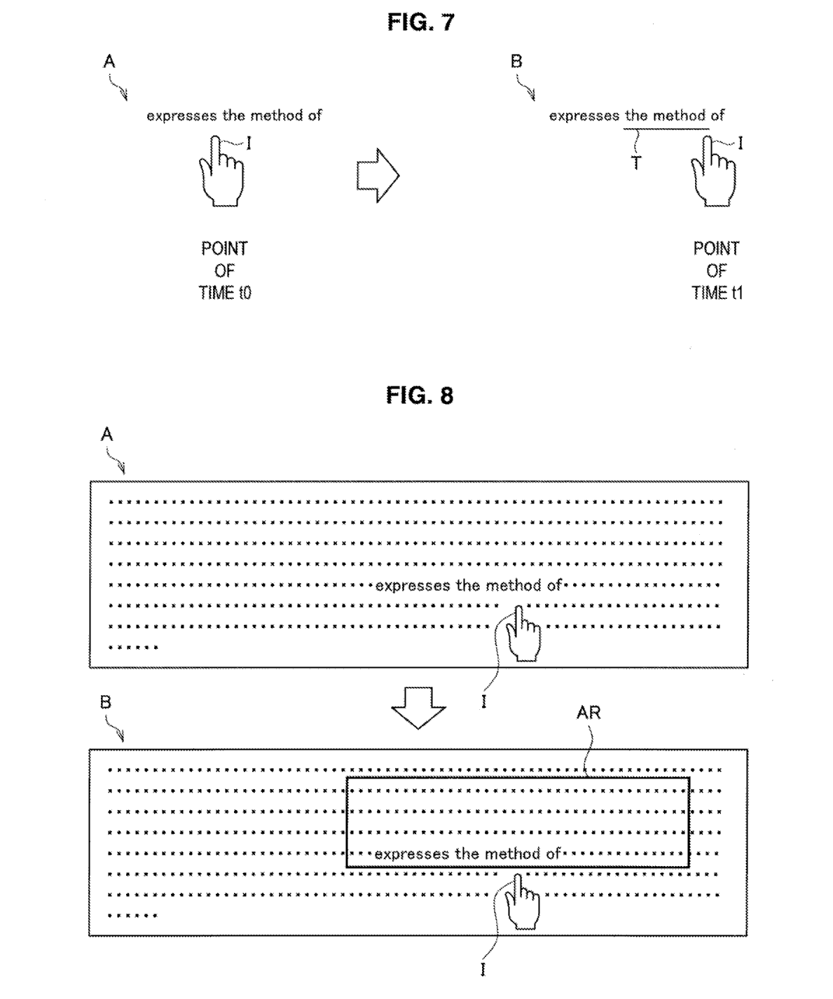

FIG. 7 is an illustration showing an example of the processing to recognize the detection target based on the positional track of the pointer made by the information processor 100 according to the embodiment of the present disclosure. FIG. 7 illustrates an example of the processing of a third method which is based on the determination of a line segment. “I” in FIG. 7 represents an example of the pointer; and “T” in FIG. 7 represents a positional track of the pointer.

As a result of drawing the track, when the track of the pointer from a stop to the next stop is represented with a line segment as shown in FIG. 7A and FIG. 7B, the information processor 100 recognizes, for example, a line segment which extends separated away from the track at a predetermined distance in a vertical direction, or a line segment itself which is drawn by the track as the detection target. For example, when a line segment extending which is separated away from the track at a predetermined distance in a vertical direction is recognized as the detection target, the information processor 100 detects, for example, a character string of “the method” marked with an underline as shown in FIG. 7B through the processing (II): (object detection processing). Also, for example, when a line segment represented by the track is recognized as the detection target, an object traced by the pointer is detected.

When the track is represented by a line segment, the processing to recognize the detection target made by the information processor 100 is not limited to the above. FIG. 8 is an illustration showing an example of the processing to recognize the detection target based on the positional track of the pointer which is made by the information processor 100 according to the embodiment of the present disclosure, which is another example of the processing using the third method based on the determination of the line segment. “I” in FIG. 8 represents an example of the pointer.

For example, in a captured image shown in FIG. 8A, when the track of the pointer is represented by a line segment, the information processor 100 recognizes an area AR of a predetermined size including the line segment as the detection target. That is, the information processor 100 estimates a closed area based on the line segment and recognizes the same as the detection target. In this case, the information processor 100 detects the characters corresponding to the track of the pointer as the object from the recognized area AR through the processing (II): (object detection processing).

In particular, the information processor 100 detects, for example, a character row corresponding to the track of the pointer from the area AR as the detection target. For example, in the example shown in FIG. 8B, four character rows are detected from the area AR. Then, the information processor 100 detects the characters corresponding to the track of the pointer from the detected character row. For example, in the example shown in FIG. 8, when a same track as the track T in FIG. 7 is drawn, the information processor 100 detects the characters of “the method”.

The information processor 100 performs OCR processing on the area AR before performing, for example, the processing (II): (object detection processing) to detect the characters. However, the processing of the information processor 100 according to the embodiment of the present disclosure is not limited to the above. For example, the information processor 100 may perform the OCR processing on the entire captured image first, and then perform the processing (II): (object detection processing) using the OCR processing result.

Referring to FIG. 4 again, a description will be made about a first example of the processing to recognize the pointer as the detection target made by the information processor 100. When it is determined that the positional track of the pointer is not a line segment in step S214, the information processor 100 recognizes the detection target using a fourth method (S218), and terminates the detection target recognition processing.

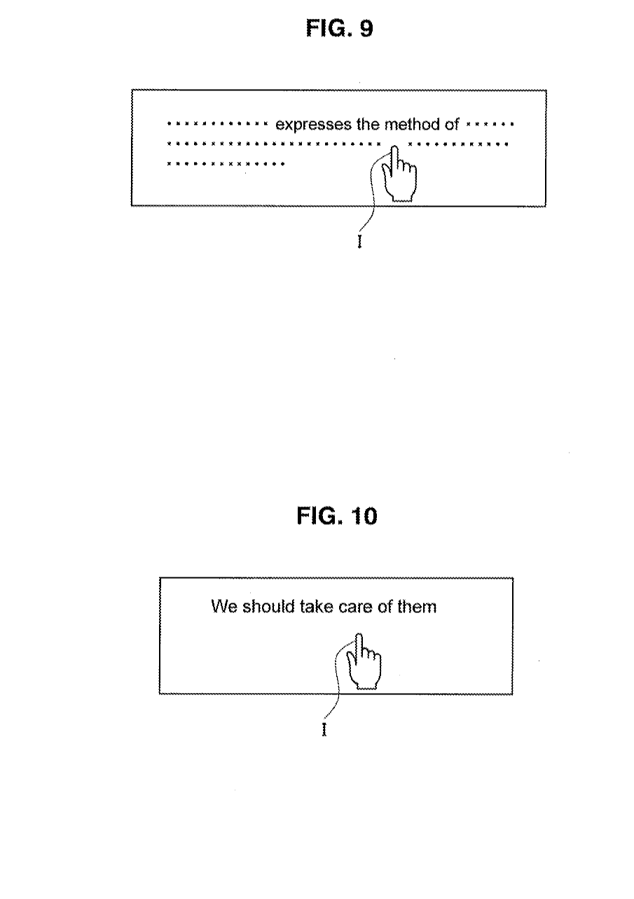

FIG. 9 and FIG. 10 are illustrations each showing an example of the processing to recognize the detection target based on the positional track of the pointer made by the information processor 100 according to the embodiment of the present disclosure. FIG. 9 and FIG. 10 illustrate an example of the processing of the fourth method. “I” in FIG. 9 and FIG. 10 represents an example of the pointer.

The information processor 100 recognizes, for example, a set of characters which exists separated away from the track at a predetermined distance in a vertical direction and a set of characters which locates at the position of the pointer as the detection target. For example, when recognizing the set of characters existing separated away from the track at a predetermined distance in a vertical direction as the detection target, the information processor 100 performs, for example, the processing (II): (object detection processing) to recognize the character rows existing separated away from the track at a predetermined distance in a vertical direction. Then, the information processor 100 recognizes, for example, a part of the recognized row of characters which is segmented by the spaces as one word, and detects the characters existing separated away from the pointer at a predetermined distance in a vertical direction as the object. For example, in the example shown in FIG. 9, a word “method” is detected.

Also, for example, when recognizing a set of characters located at the position of the pointer as the detection target, based on a result of OCR processing made on the entire of the previously captured image and the position of the pointer, the information processor 100 performs the processing (II): (object detection processing) to detect, for example, a word corresponding to the position of the pointer as the object.

The information processor 100 is capable of recognizing a phrase(s) from plural combinations of the one word detected as described above and the preceding and following words by using, for example, a phrase database as a dictionary for character recognition. For example, in the example shown in FIG. 10, when a word “care” is detected as a word, the information processor 100 detects, for example, phrases of “take care”, “take care of” and the like by using the phrase database.

When recognizing the pointer to perform the processing, the information processor 100 performs, for example, the processing shown in FIG. 4 to recognize the detection target.

The processing to recognize the pointer as the detection target made by the information processor 100 according to the embodiment of the present disclosure is not limited to the processing of the first example shown in FIG. 4. For example, FIG. 4 illustrates an example in which the information processor 100 recognizes the detection target by using any one of the first to fourth methods based on the plural determination results. However, the information processor 100 may perform the processing by using a method used for recognizing the detection target or a method in which a combination of determination processing or the like is modified. In particular, the information processor 100 is capable of recognizing the detection target by using, for example, any one of combination among the first to fourth methods (15 different combinations). In the following description, other examples of the processing to recognize the pointer as the detection target made by the information processor 100 will be given.

### [1-2] Second Example of Processing to Recognize Detection Target

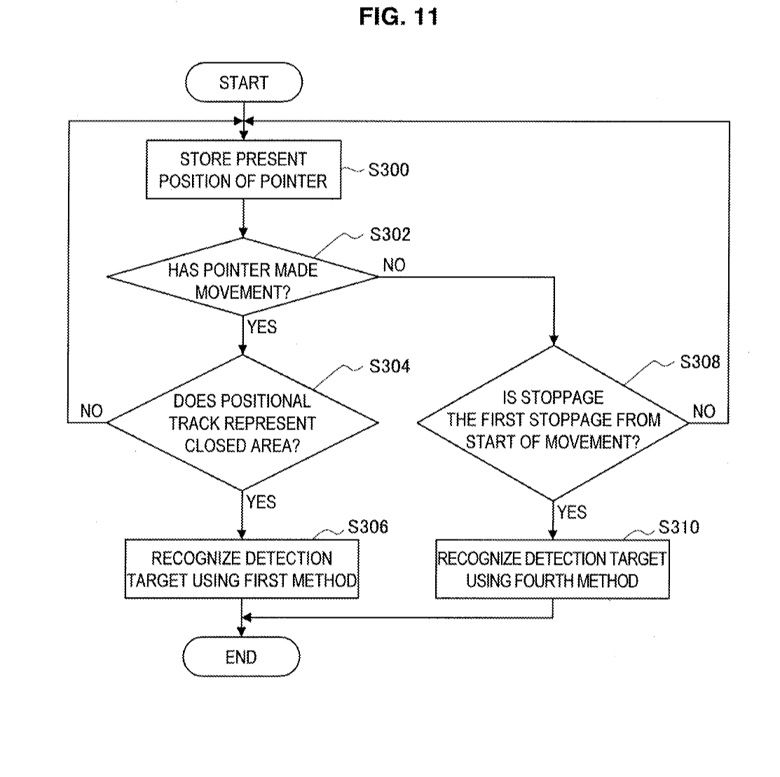

FIG. 11 is a flow chart showing a second example of the processing to recognize the detection target including recognition of the pointer made by the information processor 100 according to the embodiment of the present disclosure.

The information processor 100 stores the position of the pointer in the captured image same as step S200 in FIG. 4 (S300).

When the present position of the pointer is stored in step S300, the information processor 100 determines whether the pointer has made a movement same as step S202 in FIG. 4 (S302).

When it is determined that the pointer has made a movement in step S302, the information processor 100 determines whether the positional track of the pointer represents a closed area same as step S204 in FIG. 4 (S304). When it is determined that the positional track of the pointer does not represent a closed area in step S304, the information processor 100 repeats the processing from step S300.

When it is determined that the positional track of the pointer represents a closed area in step S304, the information processor 100 recognizes the detection target using the first method based on the determination of the closed area same as step S206 in FIG. 4, (S306). Then, the information processor 100 terminates the detection target recognition processing.

When it is determined that the pointer has made no movement in step S302, the information processor 100 determines whether the stoppage is the first stoppage from the start of the movement same as step S208 in FIG. 4 (S308). When it is determined that the stoppage is not the first stoppage from the start of the movement in step S308, the information processor 100 repeats the processing from step S300.

When it is determined that the stoppage is the first stoppage from the start of the movement in step S308, the information processor 100 recognizes the detection target using the fourth method same as step S218 in FIG. 4 (S310). Then, the information processor 100 terminates the detection target recognition processing.

### [1-3] Third Example of Processing to Recognize Detection Target

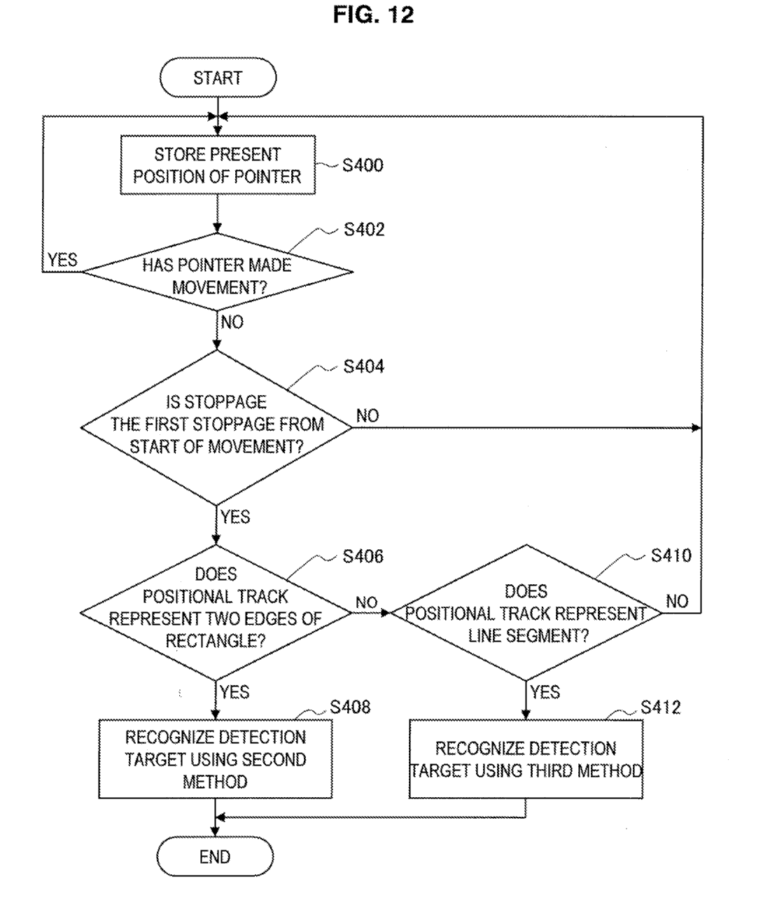

FIG. 12 is a flow chart showing a third example of the processing to recognize the detection target including recognition of the pointer made by the information processor 100 according to the embodiment of the present disclosure.

The information processor 100 stores the position of the pointer in the captured image same as step S200 in FIG. 4 (S400).

When the present position of the pointer is stored in step S400, the information processor 100 determines whether the pointer has made a movement same as step S202 in FIG. 4 (S402). When it is determined that the pointer has made a movement in step S402, the information processor 100 repeats the processing from step S400.

When it is determined that the pointer has made no movement in step S402, the information processor 100 determines whether the stoppage is the first stoppage from the start of the movement same as step S208 in FIG. 4 (S404). When it is determined that the stoppage is first stoppage from the start of the movement in step S404, the information processor 100 repeats the processing from step S400.

When it is determined that the stoppage is the first stoppage from the start of the movement in step S404, the information processor 100 determines whether the positional track of the pointer represents two edges of a rectangle same as step S210 in FIG. 4 (S406).

When it is determined that the positional track of the pointer represents two edges of a rectangle in step S406, the information processor 100 recognizes the detection target using the second method based on the determination of the two edges of a rectangle same as step S212 in FIG. 4 (S408). Then, the information processor 100 terminates the detection target recognition processing.

When it is determined that the positional track of the pointer does not represent two edges of a rectangle in step S406, the information processor 100 determines whether the positional track of the pointer represents a line segment same as step S214 in FIG. 4 (S410).

When it is determined that the positional track of the pointer does not represent a line segment in step S410, the information processor 100 repeats the processing from step S400.

When it is determined that the positional track of the pointer represents a line segment in step S410, the information processor 100 recognizes the detection target using the third method based on the determination of the line segment same as step S216 in FIG. 4 (S412). Then, the information processor 100 terminates the detection target recognition processing.

### [1-4] Fourth Example of Processing to Recognize Detection Target

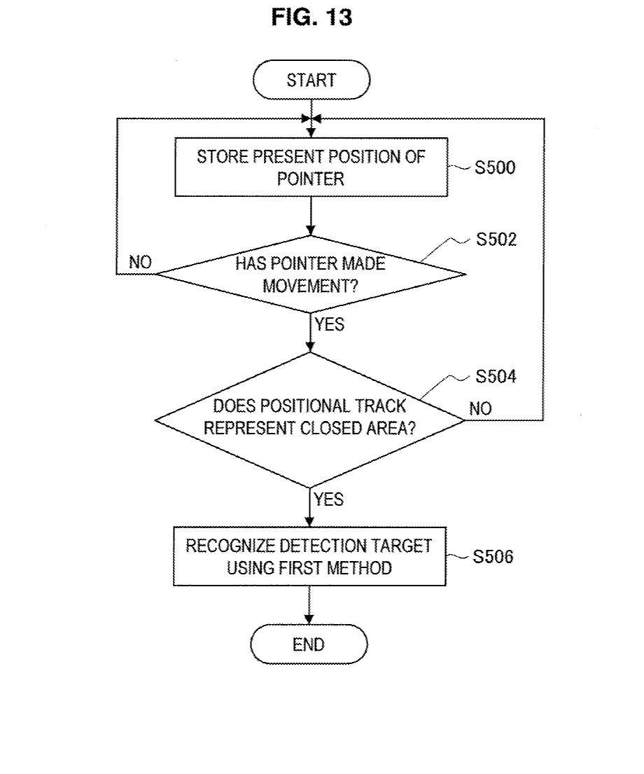

FIG. 13 is a flow chart showing a fourth example of the processing to recognize the detection target including recognition of the pointer made by the information processor 100 according to the embodiment of the present disclosure.

The information processor 100 stores the position of the pointer in the captured image same as step S200 in FIG. 4 (S500).

When the present position of the pointer is stored in step S500, the information processor 100 determines whether the pointer has made a movement same as step S202 in FIG. 4 (S502). When it is determined that the pointer has made a movement in step S502, the information processor 100 repeats the processing from step S500.

When it is determined that the pointer has made no movement in step S502, the information processor 100 determines whether the positional track of the pointer represents a closed area same as step S204 in FIG. 4 (S504). When it is determined that the positional track of the pointer does not represent a closed area in step S504, the information processor 100 repeats the processing from step S500.

When it is determined that the positional track of the pointer represents a closed area in step S504, the information processor 100 recognizes the detection target using the first method based on the determination of the closed area same as step S206 in FIG. 4 (S506). Then, the information processor 100 terminates the detection target recognition processing.

### [1-5] Fifth Example of Processing to Recognize Detection Target

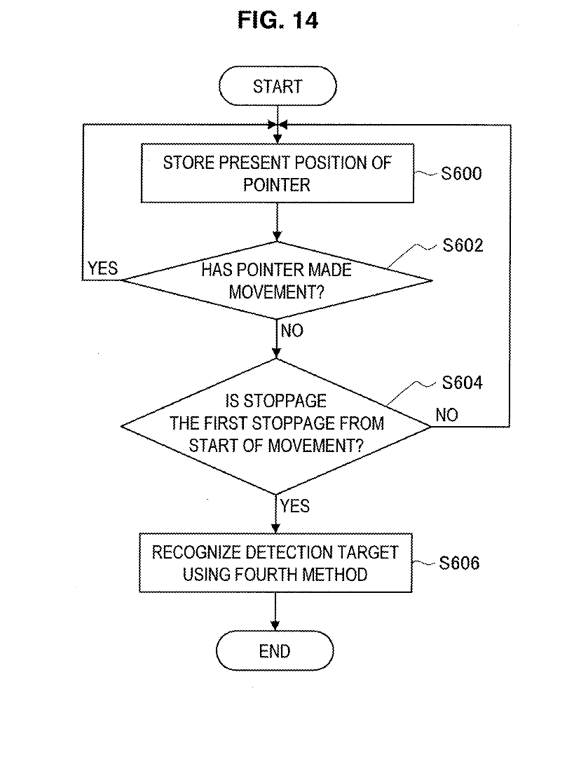

FIG. 14 is a flow chart showing a fifth example of the processing to recognize the detection target including recognition of the pointer made by the information processor 100 according to the embodiment of the present disclosure.

The information processor 100 stores the position of the pointer in the captured image same as step S200 in FIG. 4 (S600).

When the present position of the pointer is stored in step S600, the information processor 100 determines whether the pointer has made a movement same as step S202 in FIG. 4 (S602). When it is determined that the pointer has made a movement in step S602, the information processor 100 repeats the processing from step S600.

When it is determined that the pointer has made no movement in step S602, the information processor 100 determines whether the stoppage is the first stoppage from the start of the movement same as step S208 in FIG. 4 (S604). When it is determined that the stoppage is not the first stoppage from the start of the movement in step S604, the information processor 100 repeats the processing from step S600.

When it is determined that the stoppage is the first stoppage from the start of the movement in step S604, the information processor 100 recognizes the detection target using the fourth method same as step S218 in FIG. 4 (S606). Then, the information processor 100 terminates the detection target recognition processing.

### [1-6] Sixth Example of Processing to Recognize Detection Target

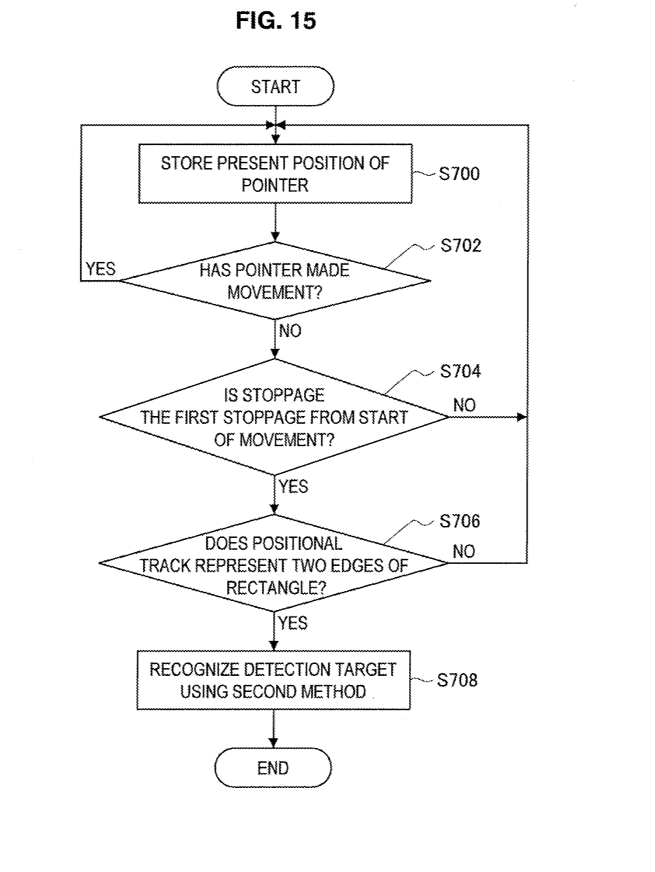

FIG. 15 is a flow chart showing a sixth example of the processing to recognize the detection target including recognition of the pointer made by the information processor 100 according to the embodiment of the present disclosure.

The information processor 100 stores the position of the pointer in the captured image same as step S200 in FIG. 4 (S700).

When the present position of the pointer is stored in step S700, the information processor 100 determines whether the pointer has made a movement same as step S202 in FIG. 4 (S702). When it is determined that the pointer has made a movement in step S702, the information processor 100 repeats the processing from step S700.

When it is determined that the pointer has made no movement in step S702, the information processor 100 determines whether the stoppage is the first stoppage from the start of the movement same as step S208 in FIG. 4 (S704). When it is determined that the stoppage is not the first stoppage from the start of the movement in step S704, the information processor 100 repeats the processing from step S700.

When it is determined that the stoppage is the first stoppage from the start of the movement in step S704, the information processor 100 determines whether the positional track of the pointer represents two edges of a rectangle same as step S210 in FIG. 4 (S706).

When it is determined that the positional track of the pointer does not represent two edges of a rectangle in step S706, the information processor 100 repeats the processing from step S700.

When it is determined that positional track of the pointer represents two edges of a rectangle in step S706, the information processor 100 recognizes the detection target using the second method based on determination of the two edges of a rectangle same as step S212 in FIG. 4 (S708). Then, the information processor 100 terminates the detection target recognition processing.

### [1-7] Seventh Example of Processing to Recognize Detection Target

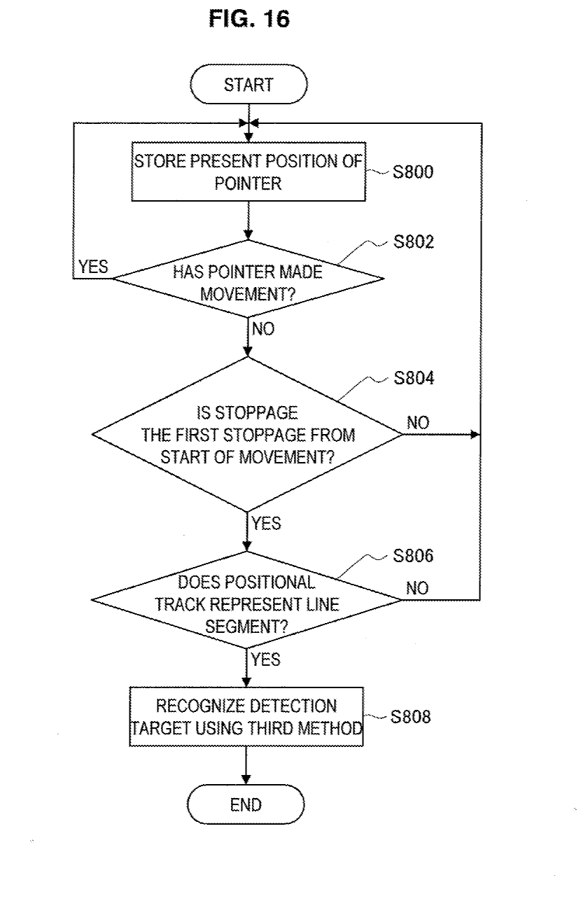

FIG. 16 is a flow chart showing a seventh example of the processing to recognize the detection target including recognition of the pointer made by the information processor 100 according to the embodiment of the present disclosure.

The information processor 100 stores the position of the pointer in the captured image same as step S200 in FIG. 4 (S800).

When the present position of the pointer is stored in step S800, the information processor 100 determines whether the pointer has made a movement same as step S202 in FIG. 4 (S802). When it is determined that the pointer has made a movement in step S802, the information processor 100 repeats the processing from step S800.

When it is determined that the pointer has made no movement in step S802, the information processor 100 determines whether the stoppage is the first stoppage from the start of the movement same as step S208 in FIG. 4 (S804). When it is determined that the stoppage is not the first stoppage from the start of the movement in step S804, the information processor 100 repeats the processing from step S800.

When it is determined that the stoppage is the first stoppage from the start of the movement in step S804, the information processor 100 determines whether the positional track of the pointer represents a line segment same as step S214 in FIG. 4 (S806).

When it is determined that the positional track of the pointer does not represent a line segment in step S806, the information processor 100 repeats the processing from step S800.

When it is determined that the positional track of the pointer represents a line segment in step S806, the information processor 100 recognizes the detection target using the third method based on the determination of the line segment same as the step S216 in FIG. 4 (S808). Then the information processor 100 terminates the detection target recognition processing.

When performing the processing by recognizing the pointer, the information processor 100 recognizes the detection target by performing, for example, the processing of one of the above first to seventh examples.

The processing to recognize the detection target after recognizing the pointer made by the information processor 100 according to the embodiment of the present disclosure is not limited to the above first to seventh examples of the processing. For example, the information processor 100 is capable of recognizing the detection target by using one or more desired combinations among the first to fourth methods (15 different combinations) as described above.

The information processor 100 may detect, for example, the shifting direction of the track, kind of the pointer or the like. As for the detected information representing the movement direction of the track (data), for example, information representing a closed area drawn clockwise/counterclockwise direction, information representing a drawing direction of line segment and the like are exemplified. Also, as for the detected information representing the kind of the pointer (data), for example, information representing the kind of fingers (example of the pointer), information indicating the type of the pointing device (example of the pointer) and the like are exemplified.

For example, the information processor 100 may use the information representing the movement direction of the track, the information representing the kind of the pointer in the processing (III): (execution processing); to thereby switch the service relevant to the processing corresponding to the object, or the application to be activated corresponding to the object. A particular example of the processing (III): (execution processing) using the information representing movement direction of the track or the like will be described below.

When performing the processing after recognizing the pointer, the information processor 100 recognizes the detection target by performing, for example, the above-described processing. Referring to FIG. 3 again, an example of the information processing method according to the embodiment of the present disclosure will be described below.

[2] Example of Processing without Recognizing Pointer

When it is determined not to recognize the pointer in step S100, the information processor 100 recognizes the detection target based on the movement of the imaging target (S106).

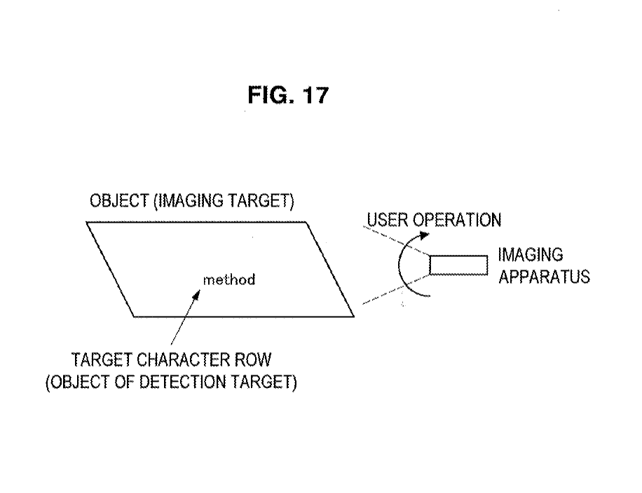

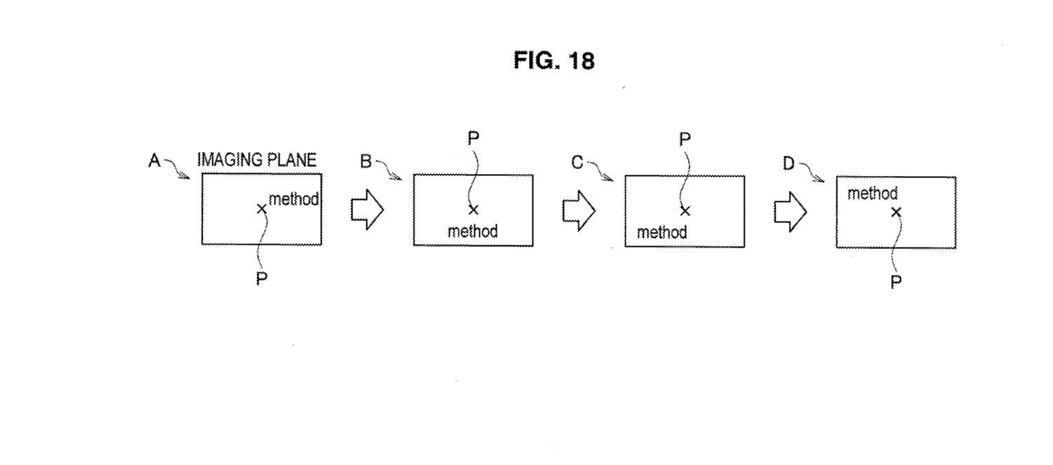

FIG. 17 and FIG. 18 are illustrations for explaining an example of the processing to recognize the detection target without recognizing the pointer made by the information processor 100 according to the embodiment of the present disclosure. FIG. 17 illustrates an example in which the user takes an image using an imaging device with unfixed imaging position as shown in FIG. 2A. As for the imaging device with unfixed imaging position is, for example, a pen-type camera, a camera integrated with a laser pointer, camera attached to user's body and the like are exemplified.

As shown in FIG. 17, when the user takes an image while moving imaging device, the captured image taken by the imaging device is an image the imaging target of which is moving. Therefore, the information processor 100 determines the movement status of the imaging target based on, for example, the changes of the image with respect to a predetermined position of the center “P” or the like of the captured image as shown in FIG. 18.

In particular, the information processor 100 determines the movement status of the imaging target based on, for example, the track of the predetermined point in the captured image taken by the user while shifting the imaging device, and recognizes the target area.

The information processor 100 uses, for example, optical flow of the imaging target in the captured image, and determines the track of the predetermined point in the captured image. The method to determine the track of the predetermined point made by the information processor 100 according to the embodiment of the present disclosure is not limited to the above. For example, when the imaging device includes, for example, a sensor which is capable of detecting the movement of the imaging device such as an acceleration sensor, a gyro-sensor and the like, the information processor 100 may determine the track of the predetermined point based on the sensor information representing a value detected by the sensor which is received from the imaging device.

The information processor 100 may recognize the detection target based on the track by performing, for example, the same processing as the processing [1]: (processing when recognizing the pointer).

When performing the processing without recognizing the pointer, the information processor 100 recognizes the detection target by performing, for example, the above processing.

Referring to FIG. 3 again, an example of the information processing method according to the embodiment of the present disclosure will be described. When the detection target is recognized through the processing in step S104 or step S106, the information processor 100 determines whether the detection target is recognized in state that both of the vertical direction and the horizontal direction thereof are recognizable (S108).

The information processor 100 makes the determination in step S108 based on, for example, the detection target recognized using any of the above-described first to fourth methods. In particular, for example, when the recognition of the detection target is made by using the first method (method in the case the track represents closed area) or the second method (method when the track represents two edges of a rectangle) the information processor 100 determines that the detection target is recognized in a state that both directions are recognizable. Also, for example, when the detection target is recognized with the third method (method when the track represents a line segment) or the fourth method (method for other cases), the information processor 100 determines the detection target is not recognized in a state that both directions are recognizable. Needless to say that the processing in step S108 made by the information processor 100 according to the embodiment of the present disclosure is not limited to the above.

When it is determined that the detection target is recognized in a state that both of the vertical direction and the horizontal direction are determined in step S108, the information processor 100 determines a character detection area for detecting the characters (S110). The information processor 100 determines an area corresponding to, for example, a closed area drawn by the track or a rectangle defined by two edges of a rectangle drawn by the track as a character detection area.

When the character detection area is determined in step S110, the information processor 100 performs, for example, OCR processing or the like to recognize the characters within the character detection area (S112) and obtain a character code (S114). Then, the information processor 100 performs the processing described below in step S116.

When it is determined that the detection target is not recognized in a state that both of the vertical direction and the horizontal direction are recognizable in step S108, the information processor 100 performs, for example, OCR processing or the like to recognize the characters in the entire imaging target or a periphery area of the pointer (for example, area AR in FIG. 8) (S118).

When the characters are recognized in step S118, the information processor 100 obtains a character code of the character row corresponding to the position of the pointer (S120). As for the character row corresponding to the position of the pointer, for example, the character row extending separated away from the track at a predetermined distance in a vertical direction or a character row locating at the position of the pointer are exemplified.

When the processing in step S120 is made, the information processor 100 obtains the character code corresponding to the position of the pointer utilizing a blank space or the like (S122).

When the processing in step S114 or step S122 is made, the information processor 100 applies the characters (an example of the detected object), which are represented by the obtained character code, to the service or applications (S116).

For example, the information processor 100 determines whether the characters represented by the character code is the user's mother tongue based on the information representing the user's mother tongue stored in the storage (described below) or the like and the obtained character code. When the characters represented by the obtained character code is not the user's mother tongue, the information processor 100 translates the characters into the user's mother tongue.

The information processor 100 also determines the meaning represented by the characters indicated by the obtained character code based on, for example, a database stored in the storage (described below) or the like and the obtained character code. For example, when the characters represented by the obtained character code mean a toponym, the information processor 100 searches for, for example, a map, routes, weather forecast and the like corresponding to the toponym, and displays the same on the display screen; to thereby present the same to a user. Also, for example, when the characters represented by the obtained character code means a shop name, the information processor 100 presents a piece of information on the shop such as, for example, word-of-mouth concerning the shop and the like to the user.

The information processor 100 performs a service relevant to the processing, for example, as described above, corresponding to the characters represented by the obtained character code based on the characters represented by the obtained character code; or activates and executes an application corresponding to the characters represented by the obtained character code.

The processing in step S116 made by the information processor 100 according to the embodiment of the present disclosure is not limited to the above. For example, the information processor 100 may use a piece of information representing movement direction of the track and/or information representing the kind of the pointer to thereby switch between a service relevant to the processing and an application to be activated corresponding to the characters represented by the obtained character code.

For example, when a piece of information representing movement direction of the track is used, the information processor 100 is capable of, for example, switching between the modes below.

When the characters represented by the obtained character code means a toponym, and when the character code is obtained by a closed area drawn by clockwise track, the information processor 100 presents a map and routes corresponding to the toponym to the user;

When the characters represented by the obtained character code means a toponym, and when the character code is obtained by a closed area drawn by counterclockwise track, the information processor 100 presents, for example, a weather forecast at a location corresponding to the toponym to the user.

The information processor 100 may switch between the service relevant to the processing and an application to be activated corresponding to the characters represented by the obtained character code based on the recognition method of the detection target used for obtaining the character code (for example, the above-described first to fourth methods and the like).

The information processor 100 performs, for example, the processing shown in FIG. 3 to achieve the information processing method according to the embodiment of the present disclosure. Accordingly, the information processor 100 performs, for example, the processing shown in FIG. 3 to thereby recognize the object while providing the user with an enhanced operability. Needless to say that the information processing method according to the embodiment of the present disclosure is not limited to the example shown in FIG. 3.

### (Information Processor According to the Embodiment of the Present Disclosure)

Subsequently, an example of a configuration of the information processor 100 of the embodiment of the present disclosure, which is capable of performing the information processing method according to the above-described embodiment of the present disclosure, will be described.

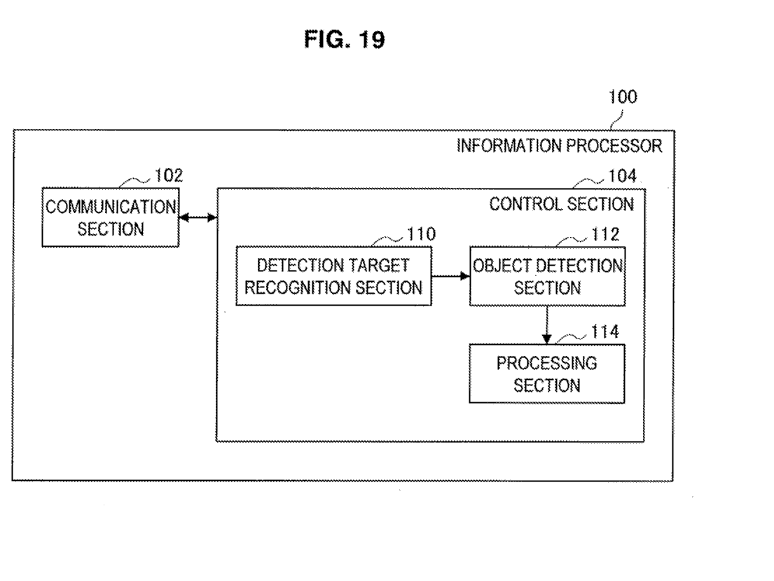

FIG. 19 is a block diagram showing an example of a configuration of the information processor 100 of the embodiment of the present disclosure. The information processor 100 includes, for example, a communication section 102 and a control section 104.

The information processor 100 also may include, for example, a ROM (read only memory; not shown), a RAM (random access memory; not shown), a storage (not shown), an operation section (not shown) which allows the user to operate thereon, a display section (not shown) which displays various pictures on a display screen, a imaging section (not shown) and the like. The information processor 100 connects the above constituent elements to each other via, for example, a bus as a data transmission line.

The ROM (not shown) stores control data such as programs and calculation parameters used by the control section 104. The RAM (not shown) temporarily store a program or the like which is executed by the control section 104.

The storage (not shown) is a storage unit included in the information processor 100, which stores various kinds of data such as, for example, image data, various kinds of information which are used for the information processing method according to the embodiment of the present disclosure such as setting information for the above constituent elements and applications. As for the storage (not shown), for example, a magnetic storage medium such as a hard disk, an EEPROM (electrically erasable and programmable read only memory), a nonvolatile memory such as flash memory are applicable. Also, the storage (not shown) may be dismountable from the information processor 100.

As for the operation section (not shown), for example, buttons, direction keys, rotatable selector such as jog dial, or a combination thereof are applicable. The information processor 100 may be connected to, for example, an operation input device (for example, a key board, a mouse and the like) as an external device for the information processor 100.

As for the display section (not shown), for example, a liquid crystal display (LCD), an organic electroluminescence display and an OLED display (organic light emitting diode display) are applicable. As for the display section (not shown), for example, a device, which is capable of display and operation by the user thereon like a touch screen, is applicable. The information processor 100 may be connected to a display device (for example, an external display) as an external device of the information processor 100 without depending on a display section (not shown) included.

The imaging section (not shown) performs a function to take still image or moving image. When an imaging section (not shown) is included, the information processor 100 is capable of, for example, processing image signals which are generated by the imaging section (not shown).

As for the imaging section (not shown) according to the embodiment of the present disclosure, for example, an imaging device which includes a lens/image pickup device and a signal processing circuit is applicable. The lens/image pickup device is configured as, for example, an image sensor including a plurality of imaging elements such as optical system lenses, a CCD (charge coupled device) and a CMOS (complementary metal oxide semiconductor). The signal processing circuit includes, for example, an AGC (automatic gain control) circuit and an ADC (analog to digital converter) which converts analog signals generated by the imaging element into digital signals (image data) to process various signals. The signal processing circuit performs signal processing such as, for example, white balance correction processing, color compensation processing, gamma correction processing, YCbCr conversion processing, edge enhancement processing.

### [Example of Hardware Configuration of Information Processor 100]

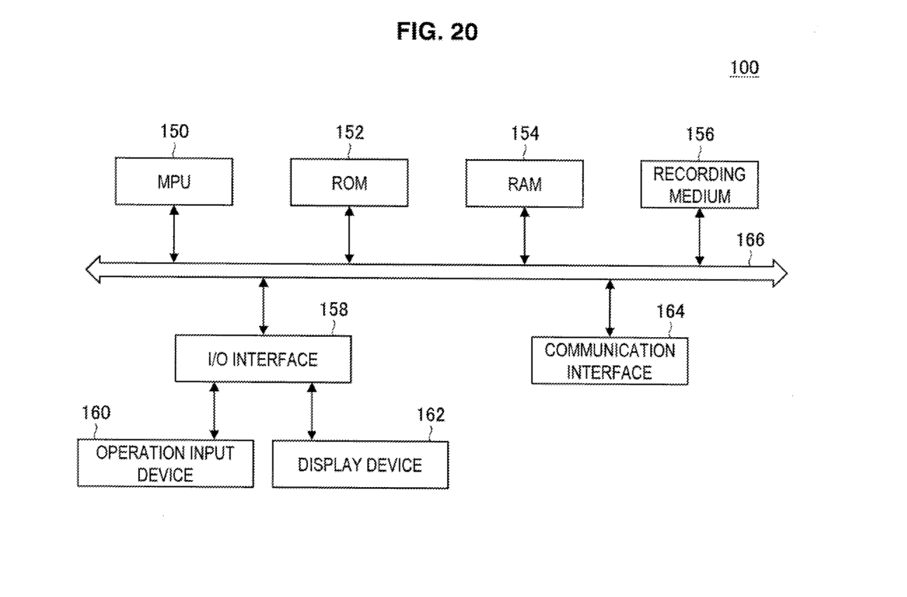

FIG. 20 is an illustration showing an example of a hardware configuration of the information processor 100 according to the embodiment of the present disclosure. The information processor 100 includes, for example, an MPU 150, a ROM 152, a RAM 154, a recording medium 156, an I/O interface 158, an operation input device 160, a display device 162 and a communication interface 164. The information processor 100 connects to the constituent elements via, for example, a bus 166 as a data transmission line.

The MPU 150 functions as a control section 104, which includes, for example, an MPU (micro processing unit) and various kinds of processing circuits, and controls entire of the information processor 100. In the information processor 100, the MPU 150 also functions as, for example, a detection target recognition section 110, an object detection section 112 and a processing section 114, which will be described below.

The ROM 152 stores programs, control data such as calculation parameters and the like which are used by the MPU 150. The RAM 154 temporarily stores, for example, a program or the like which is executed by the MPU 150.

The recording medium 156 functions as a storage (not shown) for storing various kinds of data such as, for example, image data, various kinds of information, applications and the like, which are used for performing the information processing method according to the embodiment of the present disclosure. As for the recording medium 156, for example, magnetic storage media such as a hard disk and nonvolatile memories such as a flash memory are applicable. The recording medium 156 may be dismountable from the information processor 100.

The I/O interface 158 is connected to, for example, the operation input device 160 and the display device 162. The operation input device 160 functions as an operation section (not shown); and the display device 162 functions as a display section (not shown). As for the I/O interface 158, various kinds of processing circuits such as, for example, a USB (universal serial bus) terminal, a DVI (digital visual interface) terminal, an HDMI (high-definition multimedia interface) terminal are applicable. The operation input device 160 is provided to, for example, the information processor 100 and is connected to the I/O interface 158 in the information processor 100. As for the operation input device 160, for example, buttons, direction keys, and a rotatable selector such a jog dial, or combination thereof are applicable. The display device 162 is provided to, for example, the information processor 100 and is connected to the I/O interface 158 in the information processor 100. As for the display device 162, for example, a liquid crystal display and an organic electroluminescence display are applicable.

Needless to say, the I/O interface 158 is capable to be connected to external devices such as an operation input device (for example, a key board, a mouse and the like), a display device, an imaging device (for example, imaging devices (A) shown in FIG. 1 and FIG. 2 and the like) as external devices for the information processor 100. The display device 162 may be a device capable of displaying and allowing the user to operate thereon like, for example, a touch screen and the like.

The communication interface 164 is a communication unit included in the information processor 100, which functions as the communication section 102 for performing wired/wireless communication with, for example, the imaging devices (A) shown in FIG. 1 and FIG. 2, the external devices such as a server and the like via a network (or, directly). As for the communication interface 164, for example, a communication antenna and an RF (radio frequency) circuit (wireless communication), IEEE802.15.1 port and a transmission/reception circuit (wireless communication), IEEE802.11b port and a transmission/reception circuit (wireless communication), or a LAN (local area network) terminal and a transmission/reception circuit (wired communication) and the like are applicable. As for the network according to the embodiment of the present disclosure, for example, a wired network of a LAN or a WAN (wide area network) and the like, a wireless network like a wireless LAN (WLAN; wireless local area network) or a radio network of a wireless WAN (WWAN; wireless wide area network) via a base station, or Internet using a communication protocol of TCP/IP (transmission control protocol/Internet protocol) and the like are applicable.

The information processor 100 has, for example, a configuration shown in FIG. 20 and performs the information processing method according to the embodiment of the present disclosure. However, the hardware configuration of the information processor 100 according to the embodiment of the present disclosure is not limited to the configuration shown in FIG. 20.

For example, the information processor 100 may be further provided with a DSP (digital signal processor) and an audio output device including an amplifier, a speaker and the like. When the DSP and the audio output device are provided, the information processor 100 is capable of providing the user audio information corresponding to, for example, a detected object (for example, a piece of information which is obtained by performing processing relative to a service or by executing an applications).

Also, the information processor 100 may be further provided with, for example, an imaging device including a lens/image pickup device and a signal processing circuit. When the imaging device is provided, the information processor 100 functions as an imaging device and is capable of processing captured images taken by the imaging device.

When the information processor 100 is configured to perform the processing independently, the communication interface 164 may not be provided. Further, the information processor 100 may be configured not to be provided with the operation input device 160 or the display device 162.

Referring to FIG. 19 again, an example of the configuration of the information processor 100 will be described. The communication section 102 is a communication unit included in the information processor 100, which performs wireless or wired communication with the external devices such as the imaging devices (A) shown in FIG. 1 and FIG. 2, the server and the like via the network (or, directly). The communication of the communication section 102 is controlled by, for example, the control section 104. As for the communication section 102, for example, a communication antenna and an RF circuit, a LAN terminal and a transmission/reception circuit and the like are applicable. However, the configuration of the communication section 102 is not limited to the above. For example, the communication section 102 may adopts any configuration conforming to any standard, which is capable of performing communication with a USB terminal and a transmission/reception circuit; or any configuration which is capable of performing communication with the external devices via the network.

By the communication section 102 included, the information processor 100 performs, for example, “making a reference to a dictionary for character recognition which is stored in an external device of the server and the like”; or “causing the external devices to execute OCR processing, or a part or all processing from the processing (I): (detection target recognition processing) to the processing (III): (execution processing)”; or “obtaining data used for the processing (III): (execution processing) from the external devices” or the like.

The control section 104 includes, for example, an MPU and the like, and controls entire of the information processor 100. The control section 104 also includes, for example, the detection target recognition section 110, the object detection section 112 and the processing section 114, and takes an initiative role to control the information processing method according to the embodiment of the present disclosure.

The detection target recognition section 110 takes an initiative role to control the processing (I): (detection target recognition processing) to recognize a detection target based on the movement status of the pointer or the movement status of the imaging target which is detected based on the captured image. In particular, the detection target recognition section 110 recognizes, for example, as described with reference to steps S102-S106 in FIG. 3, the detection target based on the positional track of the pointer in the captured image or based on the change of the image with respect to a predetermined point in the captured image.

The object detection section 112 takes an initiative role to control the processing (II): (object detection processing) to detect the object from the recognized detection target. The object detection section 112 performs various image processing such as, for example, OCR processing, edge detection, pattern matching, face detection or the like to thereby detect the object of the detection target from the recognized detection target.

The processing section 114 takes an initiative role to control the processing (III): (execution processing) and performs the processing corresponding to the object based on the detected object. In particular, the processing section 114 performs, for example, the processing according to the service corresponding to the detected object, and also activates an application corresponding to the detected object and executes the same.

The processing section 114 further uses, for example, the information representing the movement direction of the track which is obtained by the processing (I): (detection target recognition processing), the information representing the kind of the pointer, and the information representing the recognition method of the detection target (for example, the above-described first method to fourth method and the like), to switch the processing to be executed. That is, the processing section 114 is capable of performing the processing corresponding to the detected object and the process of the object detection.

The control section 104 includes, for example, the detection target recognition section 110, the object detection section 112 and the processing section 114 and takes an initiative role to control the information processing method according to the embodiment of the present disclosure.

The configuration for achieving the information processing method according to the embodiment of the present disclosure is not limited to the configuration of the control section 104 shown in FIG. 19. For example, the control section 104 according to the embodiment of the present disclosure may have a configuration in which the processing section 114 is not included. Even when a configuration in which the processing section 114 is not included is adopted, the information processor 100 according to the embodiment of the present disclosure is capable of performing the processing (I): (detection target recognition processing) and the processing (II): (object detection processing) relevant to the information processing method according to the embodiment of the present disclosure. Therefore, even when a configuration without the processing section 114 is adopted, the information processor 100 of the embodiment of the present disclosure is capable of recognizing the object while providing the user with an enhanced operability.

The information processor 100 has, for example, the configuration shown in FIG. 19 to thereby perform the information processing method according to the embodiment of the present disclosure (for example, the processing (I): (detection target recognition processing) and the processing (II): (object detection processing)). Therefore, the information processor 100 has, for example, the configuration shown in FIG. 19, and is capable of recognizing the object while providing the user with an enhanced operability.

Also, the information processor 100 has, for example, the configuration shown in FIG. 19 to thereby perform the processing (III): (execution processing). Therefore, the information processor 100 is capable of performing the processing corresponding to the detected object, the processing corresponding to the progress of the detected object, and the detection process of the object; thus the convenience for the user is further increased.

As described above, the information processor 100 according to the embodiment of the present disclosure performs, for example, the processing (I): (detection target recognition processing) and the processing (II): (object detection processing) as the information processing method according to the embodiment of the present disclosure, and detects the object based on the captured image. The information processor 100 determines the movement status of the pointer or the movement status of the imaging target based on the captured image; to thereby recognize the detection target. That is, different from the case in which the related art is applied, the user of the information processor 100 may not perform plural different operations such as the operation relevant to the pointing posture and the operation relevant to the selecting posture. By performing intuitive and simple operations such as, for example, “point”, “enclose”, “trace”, the user of the information processor 100 can cause the information processor 100 to detect an object corresponding to the operation. Accordingly, the user of the information processor 100 may not make himself/herself familiarized with the operation. Therefore, different from the case using an apparatus employing the related art, the user can control the information processor 100 to detect the object with intuitive operations.

Accordingly, the information processor 100 can recognize the object while providing the user with an enhanced operability.

Further, the information processor 100 performs the processing (III): (execution processing) as the information processing method according to the embodiment of the present disclosure, to perform the processing corresponding to the detected object. In accordance with the detected object, the information processor 100 switches the processing relevant to the service or the application to be activated corresponding to the object. By using the information representing the movement direction of the track, the information representing the kind of the pointer, and the information representing the recognition method of the detection target (for example, the first method to fourth methods and the like), the information processor 100 is capable of switching the service relevant to the processing or the application to be activated. That is, by changing, for example, the designation of the object of the detection target or the kind of the pointer used for designation, the user of the information processor 100 can control the information processor 100 to perform desired processing.

Accordingly, the information processor 100 can improve the convenience and operability for the user.

Since the information processor 100 performs the processing based on the captured image, any of a non-electric medium or an electric medium is applicable to the medium for the object to be detected. Even when an electric medium is used as the medium for the object to be detected, since the information processor 100 performs the processing based on the captured image, a detecting sensor such as a touch panel may not be provided.

As described above, the information processor 100 has been described as the embodiment of the disclosure. However, the present disclosure is not limited to the above-described embodiment. The embodiment is applicable to various apparatuses including, for example, communication apparatuses such as mobile phone, Smartphone or the like; video/music reproduction apparatus (or video/music recording-reproduction apparatus), game machine, computers such as PC (personal computer), imaging devices such as digital camera.

### (Program According to the Embodiment of the Present Disclosure)

A program which causes a computer to function as the information processor according to the embodiment of the present disclosure; i.e., (a program which is capable of executing the information processing method according to the embodiment of the present disclosure; for example, “the processing (I): (detection target recognition processing) and the processing (II): (object detection processing)”, or the processing (I), the processing (II), and the processing (III): (execution processing)” and the like) can recognize an object while providing the user with an enhanced operability.

It should be understood by those skilled in the art that various modifications, combinations, sub-combinations and alterations may occur depending on design requirements and other factors insofar as they are within the scope of the appended claims or the equivalents thereof.

For example, the information processor according to the embodiment of the present disclosure may be configured including the detection target recognition section 110, the object detection section 112 and the processing section 114 shown in FIG. 19 each of which is separated from each other (for example, the detection target recognition section 110 is constituted by separated processing circuits).

In the above description, a program (computer program) which causes, for example, a computer to function as the information processor according to the embodiment of the present disclosure has been described. However, the embodiment further provides a recording medium storing the above program.

The above-described configurations are described only for purpose of explaining the examples of embodiments of the present disclosure. Accordingly, the explained examples are included in the technical range of the present disclosure.

Additionally, the present technology may also be configured as below.

(1) An information processor, comprising:

a detection target recognition section that recognizes a detection target based on a movement status of a pointer or a movement status of an imaging target which are detected based on a captured image; and

an object detection section that detects an object from a recognized detection target.

(2) The information processor according to (1), wherein the detection target recognition section recognizes the detection target after determining the movement status of the pointer based on a positional track of the pointer in the captured image.

(3) The information processor according to (2), wherein the detection target recognition section recognizes the detection target based on a determination result of whether the positional track of the pointer represents a closed area, two edges of a rectangle or a line segment.

(4) The information processor according to (3), wherein when it is determined that the positional track of the pointer represents two edges of a rectangle or the track represents a line segment, the detection target recognition section recognizes the detection target by estimating a closed area based on the two edges of the rectangle or the line segment.

(5) The information processor according to (1), wherein the detection target recognition section recognizes the detection target by determining the movement status of the imaging target based on the changes of the image with respect to a predetermined point in the captured image.

(6) The information processor according to any one of (1) to (5), wherein the object detection section detects characters as the object by performing optical character recognition on the recognized detection target.

(7) The information processor according to (6), wherein the object detection section detects a character row corresponding to a movement of the pointer or a movement of the imaging target from the detection target, and then

detects characters corresponding to a movement of the pointer or a movement of the imaging target from the detected character row.

(8) The information processor according to any one of (1) to (7), further comprising a processing section that performs the processing corresponding to the object based on a detected object.

(9) An information processing method, comprising:

recognizing a detection target based on a movement status of a pointer or a movement status of an imaging target which are detected based on a captured image; and

detecting an object from a recognized detection target.

What is claimed is:

1. An information processor, comprising:
a detection target recognition section that recognizes a detection target based on a movement status of a pointer or a movement status of an imaging target which are detected based on a captured image; and
an object detection section that detects an object from a recognized detection target.

2. The information processor according to claim 1, wherein the detection target recognition section recognizes the detection target after determining the movement status of the pointer based on a positional track of the pointer in the captured image.

3. The information processor according to claim 2, wherein the detection target recognition section recognizes the detection target based on a determination result of whether the positional track of the pointer represents a closed area, two edges of a rectangle or a line segment.

4. The information processor according to claim 3, wherein when it is determined that the positional track of the pointer represents two edges of a rectangle or the track represents a line segment, the detection target recognition section recognizes the detection target by estimating a closed area based on the two edges of the rectangle or the line segment.

5. The information processor according to claim 1, wherein the detection target recognition section recognizes the detection target by determining the movement status of the imaging target based on the changes of the image with respect to a predetermined point in the captured image.

6. The information processor according to claim 1, wherein the object detection section detects characters as the object by performing optical character recognition on the recognized detection target.

7. The information processor according to claim 6, wherein the object detection section detects a character row corresponding to a movement of the pointer or a movement of the imaging target from the detection target, and then
detects characters corresponding to a movement of the pointer or a movement of the imaging target from the detected character row.

8. The information processor according to claim 1, further comprising a processing section that performs the processing corresponding to the object based on a detected object.

9. An information processing method, comprising:
recognizing a detection target based on a movement status of a pointer or a movement status of an imaging target which are detected based on a captured image; and
detecting an object from a recognized detection target.
